(19) United States
(12) Patent Application Publication
(10) Pub. No.: US 2009/0293033 A1
(43) Pub. Date: Nov. 26, 2009

(54) System and method for layout design of integrated circuit

(75) Inventor: Katsutoshi Ito, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/453,559

(22) Filed: May 14, 2009

(30) Foreign Application Priority Data
May 20, 2008 (JP) 2008-132437

(51) Int. Cl. G06F 17/50

(52) U.S. Cl. 716/6; 716/12; 716/11

(57) ABSTRACT

A layout design system is provided with a storage device, a design processor, and an output device. The storage device stores interconnection-routed layout data of an integrated circuit. The design processor detects an interconnection violating a timing constraint based on the interconnection-routed layout data and modifies the interconnection-routed layout data so as to provide a space around the detected interconnection and to change a width of the detected interconnection by using the provided space. The output device outputs the modified interconnection-routed layout data.

### INCORPORATION BY REFERENCE

This application claims the benefit of priority based on Japanese Patent Application No. 2008-132437, filed on May 20, 2008, the disclosure of which is incorporated herein by reference.

### BACKGROUND OF THE INVENTION

1. Field of the Invention

The present invention relates to a system and method for integrated circuit layout design, in particular, to an interconnection routing technique for integrated circuit design.

2. Description of the Related Art

One conventional approach for addressing timing violation found after routing in an integrated circuit design process is to inserting repeaters or buffers, which are typically composed of two serially connected inverters. In some cases, however, insertion of a best-determined number of repeaters with the best-determined size may be insufficient for addressing timing violation. This results from the fact that the operation of an integrated circuit manufactured by a recent dimension-reduced process is greatly affected by the interconnection resistance and the signal delay is mainly determined by the interconnection resistance.

It should be noted that a user does not always know the actual layouts of respective interconnections, since automatic interconnection tools are often used for interconnection routing. In addition, positions where the interconnection resistance is excessively large can hardly be found before interconnections are actually routed. Therefore, it is difficult to determine interconnection widths for the sufficient reduction of the interconnection resistance so that satisfy characteristics requirements.

Japanese Laid Open Patent Application No. P2001-290854 discloses a related technique for designing for a signal propagation circuit. In this related technique, multiple buffers which are substantially equal in the buffer size and the fan-out number are inserted into a signal interconnection which has a plurality of branches. The buffers are inserted between the input of the input-stage buffer and the output of the output-stage buffer so that the interconnection lengths between the respective buffers and the output interconnection length of the output-stage buffer are substantially equal to one another. The buffer sizes and the number of buffers are independently selected according to a specific calculation expression so as to minimize the signal propagation delay time at the output of the output-stage buffer.

In addition, Japanese Laid Open Patent Application No. P2005-242642 discloses a simulation apparatus and a design method of a semiconductor integrated circuit. In this technique, a cycle base model for a circuit to be designed is constituted of a state control module model, an operation module model, and a memory model. In the operation module model, algorithm notation is used and components in hardware, such pipelines, are correlated to operations each of which is to be processed in a single clock cycle. High-speed simulation is achieved by absorbing the timing delay by the weight state of the state control module model. Power consumption can be estimated by adding information of the cell sizes, the interconnection capacitances and so on to the result of activation ratio measurement of the simulation model. Preferential placement and routing of function modules is performed on the basis of the measurement result. This allows the power reduction design by repeating simulation to obtain optimum placement and routing.

Also, Shin et al. discloses an interconnection shoving technique in a thesis titled “A Detailed Router Based on Incremental Routing Modifications: Mighty”, IEEE TRANSACTIONS ON COMPUTER-AIDED DESIGN, VOL. CAD-6, NO. 6, NOVEMBER (1987), p. 942. In this document, the interconnection shoving is performed to address a DRC (Design Rule Checking) error.

### SUMMARY

In an aspect of the present invention, a layout design system is provided with a storage device, a design processor, and an output device. The storage device stores interconnection-routed layout data of an integrated circuit. The design processor detects an interconnection violating a timing constraint based on the interconnection-routed layout data and modifies the interconnection-routed layout data so as to provide a space around the detected interconnection and to change a width of the detected interconnection by using the provided space. The output device outputs the modified interconnection-routed layout data.

In another aspect of the present invention, a layout design method includes: providing interconnection-routed layout data of an integrated circuit; detecting an interconnection violating a timing constraint based on the interconnection-routed layout data; modifying the interconnection-routed layout data so as to provide a space around the detected interconnection and to change a width of the detected interconnection by using the provided space; and outputting the modified interconnection-routed layout data.

In still another aspect of the present invention, a computer-readable recording medium records a program that when executed controls a computer to perform a method comprising: providing interconnection-routed layout data of an integrated circuit; detecting an interconnection violating a timing constraint based on said interconnection-routed layout data; modifying said interconnection-routed layout data so as to provide a space around said detected interconnection and to change a width of said detected interconnection by using said provided space; and outputting said modified interconnection-routed layout data.

The present invention allows modifying an integrated circuit layout so as to increase the timing margin and to reduce the power consumption.

### BRIEF DESCRIPTION OF THE DRAWINGS

The above and other advantages and features of the present invention will be more apparent from the following description taken in conjunction with the accompanied drawings, in which:

FIG. 1 is a block diagram schematically showing an exemplary configuration of a layout design system in one embodiment of the present invention;

FIG. 2 is a flow chart showing an exemplary layout design process in one embodiment of the present invention;

FIG. 3A is a conceptual diagram showing exemplary contents of layout data after routing;

FIG. 3B is a conceptual diagram showing exemplary contents of modified layout data;

FIG. 4A is a conceptual diagram showing exemplary contents of layout data after routing;

FIG. 4B is a conceptual diagram showing exemplary contents of modified layout data;

FIG. 4C is a conceptual diagram showing further improved layout data;

FIG. 5 is a graph showing relation between the interconnection width (w) and the sheet resistance (Rs);

FIG. 6 is a graph showing relation between the interconnection width (w) and the interconnection capacitance per unit length (Cap); and

FIG. 7 is a graph showing an example of a shoved interconnection.

### DESCRIPTION OF PREFERRED EMBODIMENTS

The invention will be now described herein with reference to illustrative embodiments. Those skilled in the art would recognize that many alternative embodiments can be accomplished using the teachings of the present invention and that the invention is not limited to the embodiments illustrated for explanatory purposed.

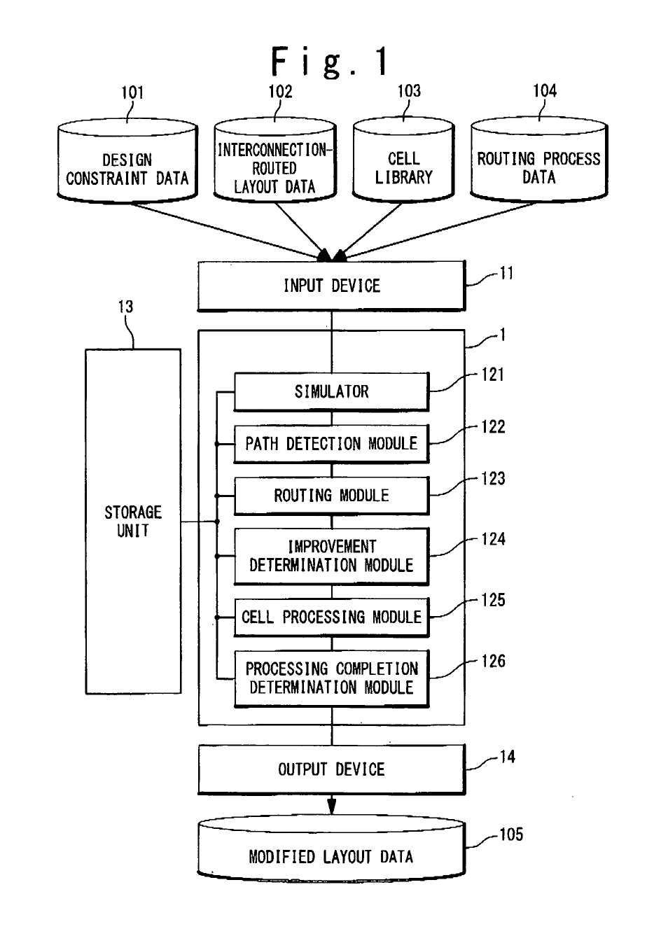

In one embodiment of the present invention, a layout design system is provided with an input device 11, a design processor 12, a storage unit 13 and an output device 14 as shown in FIG. 1.

The input device 11 receives inputs of execution commands, various settings, necessary information and the like from a system administrator. The various settings include environment settings and execution command settings for layout design in accordance with predetermined execution conditions. In this embodiment, the input device 11 receives design constraint data 101, interconnection-routed layout data 102, a cell library 103 and routing process data 104. The design constraint data 101 indicate design constraints in terms of timing and electromigration (EM). The design constraint data 101 include timing constraint data and EM constraint data. The timing constraint data are design-specific constraint data given to a design tool. The timing constraint data are described in accordance with the SDC (Synopsys Design Constraints) format, which is an industry standard format. The timing constraint data defines maximum delays in data transfer between flip-flops (FF) connected to each clock line by defining the frequency of the each clock line. For example, when a terminal called as AAA/BBB/C is defined as a clock source and the clock frequency is defined as “20 ns”, the expression is as follows:

create_clock=[get_pins AAA/BBB/C]−period 20.

The EM constraint data are given to a development tool as a library. The EM constraint data define a maximum operating frequency for each output terminal. Here, the maximum operating frequency (F_max) is determined by the load capacitance (C_load) connected to the output terminal of interest and the waveform distortion (TRF). The library describes a table for determining the maximum operating frequency by the following formula:

F_max=F(C_load, TRF).

The interconnection-routed layout data 102 are layout data generated as a result of the interconnection routing previously performed. The interconnection-routed layout data 102 may be layout data described in a circuit library format based on LEF (Library Exchange Format)/DEF (Design Exchange Format), which is proposed by U.S. Cadence (registered trademark) Inc. It should be noted, however, the present invention is not actually limited to this examples.

The cell library 103 includes layout data describing various basic logic functions as combination of logic gates. In this embodiment, the cell library 103 includes data related to standard cells and hard macros. For example, the cell library 103 includes netlists and layout data of various cells incorporating logic gate circuits. The cell library 103 also includes timing data indicative of the changes in the timing for a change of a cell size, for example, for a change of a gate width.

The routing process data 104 include data on interconnection capacitances and resistances. For example, the routing process data 104 include data representing the relationship between the interconnection width and interconnection resistance.

The design processor 12 performs processing based on data received by the input device 11. In this embodiment, the design processor 12 obtains the data inputted to the input unit 11 and stores the obtained data and the processing result into the storage unit 13 and outputs the processing result to the output device 14.

As shown in FIG. 1, the design processor 12 is provided with a simulation module 121, a path detection module 122, a routing module 123, an improvement determination module 124, a cell processing module 125 and a processing completion determination module 126.

The simulation module 121 performs simulation on the interconnection-routed layout data 102, referring to the design constraint data 101, the cell library 103 and the routing process data 104. For example, the simulation module 121 performs simulation for DRC (Design Rule Checking) or STA (Static Timing Analysis). The simulation module 121 analyzes delay times by simulation using the layout data (which are indicative of the interconnection resistances) and the netlist. It should be noted that the simulation module 121 is designed to be able to perform simulation with respect to modified layout data 105 obtained as the result of the design method of this embodiment.

The path detection module 122 lists paths in an ascending order of the timing slacks in accordance with the result of simulation. The timing slack refers to the timing margin of each path, which represents how much minute delay can be detected. Generally, the paths to be listed are often provided between flip-flops or between latches. It should be noted, however, that the present invention is not actually limited to these examples.

The routing module 123 modifies the layout data 102 so as to provide a space around a selected interconnection of a selected net within each listed path to enlarge the interconnection width of the selected interconnection by using the space. In this manner, the routing module 123 is adapted to modify the arrangement and width of a selected interconnection. The width and length of the space to be provided are dependent on the desired increase in the interconnection width, that is, the desired decrease in the interconnection resistance. Here, the reason why the interconnection width is increased (not decreased) is that, in general, thinnest interconnections are first arranged in the layout design process, and the widths of desired ones of interconnections are increased when the interconnection widths of the desired interconnections are modified. The routing module 123 may reduce an interconnection width if allowed. When a sufficiently large space cannot be provided around an interconnection of interest in the same interconnection layer, the interconnection may be rearranged so as to pass through another interconnection layer. In one embodiment, the routing module 123 may arrange an interconnection on another interconnection layer in parallel with the interconnection of interest, thereby reducing the interconnection resistance.

The improvement determination module 124 determines whether or not the timing slacks of the listed paths are sufficiently improved by providing the space around each interconnection of interest. In other words, the improvement determination module 124 determines whether or not the timing slacks are increased, providing the timing margins. For example, the improvement determination module 124 determines that the timing margin is provided, when the timing slack is more than 0. The fact that the timing slack is a positive value implies that there is a timing margin, and the fact that the timing slack is a negative value implies that the timing is later than desired value, requiring resolution of the delay time. Here, the improvement determination module 124 determines whether or not the timing slack is improved based on the analysis result of the delay times obtained by the simulation based on the layout data (interconnection resistance value) and the netlist by the simulation module 121.

The cell processing modules 125 resizes (changes the sizes of) desired cells which drive the target nets so as to satisfy the design constraints when the timing slack of a listed path is sufficiently improved. The resizing is mainly accompanied by downsizing (cell size reduction). The downsizing mainly means the reduction in the gate width of the cell. It should be noted that the resizing also includes the size change to zero. In other words, removal of a cell is one form of the resizing in this embodiment. Here, the cell implies a repeater such as a buffer and an inverter. In the case where the cell is an inverter, it is preferable that the cell processing module 125 does not remove the inverter but only performs downsizing. In the case where the inverter needs to be removed, the cell processing module 125 desirably removes multiples of two of inverters simultaneously. However, the present invention is not actually limited to these examples.

The processing completion determination module 126 determines whether or not all of the listed paths are processed. When the processes are completed for all the listed paths, the processing completion determination module 126 transfers the modified layout data 105 to the output device 14. The processing completion determination module 126 may also send data for preparing the modified layout information 105 to output device 14. Details of the modified layout data 105 will be described later.

The storage unit 13 stores data received from the design processor 12 therein and provides stored data to the design processor 12 upon the request from the design processor 12. The storage unit 13 may also previously store the design constraint data 101, the library 103 and the routing process data 104 therein. When the design processor 12 executes a program and performs processing based on the program, the storage unit 13 stores the program therein and provides the program to the design processor 12 as needed.

The output device 14 outputs data received from the design processor 12 in predetermined output formats. The output device 14 may visually display the data received from the design processor 12 or send data to a communication device on a network.

In this embodiment, the output device 14 is adapted to receive the modified layout information 105 from the design processor 12 and outputs the modified layout data 105. The output device 14 may automatically generate the modified layout data 105 based on the data received from the design processor 12 and output the modified layout data 105 according to predetermined conditions.

The modified layout data 105 are layout data generated as the result of processing for improving timing and power consumption from the interconnection-routed layout data 102 in this embodiment.

One example of the input device 11 is an interface (I/F) for obtaining data from an external input device or a storage device. Other examples of the input device 11 include a keyboard or a keypad, an on-screen keypad, a touch panel, a tablet, a reading device for storage media and so on. It should be noted, however, that the present invention is not actually limited to these examples.

Examples of the design processor 12 include processing devices such as a CPU (Central Processing Unit), a microprocessor and a semiconductor integrated circuit (IC) having similar functions. The simulation module 121, the path detection module 122, the routing module 123, the improvement determination module 124, the cell processing module 125 and the processing completion determination module 126 may be a program which causes a computer to perform respective functions, respectively. It should be noted, however, that the present invention is not actually limited to these examples.

Examples of the storage unit 13 include a semiconductor storage device such as a memory, an external storage device (storage) such as a hard disk, and other storage media. However, the present invention is not actually limited to these examples.

Furthermore, one example of the output device 14 is an interface for outputting data to the external output device or the storage device. Other examples of the output device 14 include display devices such as an LCD (liquid crystal display), a PDP (plasma display), an organic electroluminescence display, projection devices such as a projector for projecting displayed contents to a wall or a screen and printing devices such as a printer for printing displayed contents on a sheet or the like. It should be noted, however, that the present invention is not actually limited to these examples.

The layout design system of this embodiment generates layout data with improved timing and power consumption by modifying the interconnection-routed layout data 102 on the basis of the design constraints related to operation timing and electromigration and the library including data of standard cells and hard macros.

It should be noted that the design method of this embodiment covers the layout data obtained as a result of routing in the integrated design procedure. This feature is based on the fact that it is difficult to adequately predict the timing depending on the interconnections and the power consumption before the routing process or during the routing process. Therefore, the design method of this embodiment adopts an approach in which the routing process is followed by modification of the layout data obtained by the routing process.

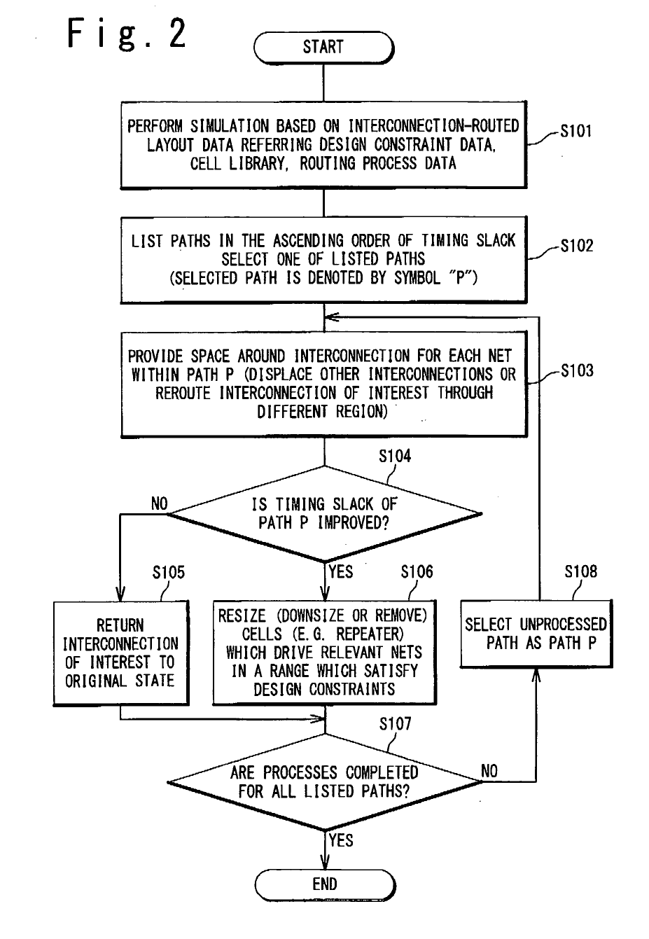

In the following, a description is given of an exemplary operation of the design processor 12 in the layout design system of this embodiment, referring to FIG. 2. In other words, FIG. 2 shows an exemplary procedure of the layout design method of this embodiment.

### (1) Step S101

When receiving the interconnection-routed layout data 102, the simulation module 121 starts processing. In this embodiment, the simulation module 121 performs simulation based on the interconnection-routed layout data 102, referring to the design constraint data 101, the cell library 103 and the routing process data 104. The simulation module 121 may receive the design constraint data 101, the cell library 103 and the routing process data 104 from the input device 11 along with the interconnection-routed layout data 102 at the same time. Alternatively, when receiving the interconnection-routed layout data 102, the simulation module 121 may also refer the design constraint data 101, the cell library 103 and the routing process data 104 which are previously stored in the storage unit 13. As a result of simulation, the simulation module 121 detects interconnections violating the timing constraints.

### (2) Step S102

As a result of the simulation, the path detection module 122 lists the paths in the ascending order of the timing slacks, and sequentially selects the listed paths. In this embodiment, the selected path is denoted by the numeral “P”. In other words, the path P refers to the selected path.

### (3) Step S103

Subsequently, the routing module 123 performs “spacing”, which involves providing a space around a selected interconnection of a selected net within the path P to modify the layout data. In this step, the routing module 123 provides the space by displacing another interconnection as much as possible or performing rerouting to avoid other interconnections. Thereby, the routing module 123 can reduce the interconnection capacitance of the net. Furthermore, the routing module 123 reduces the resistance of a selected interconnection by increasing the interconnection width. The routing module 123 may partially increases the interconnection width of an interconnection when the interconnection width cannot be uniformly increased due to limitations of the space or the like. In this case, the routing module 123 increases the width of only the portion of the interconnection around which there is space sufficient to increase the interconnection width.

### (4) Step S104

The improvement determination module 124 determines whether the timing slack of the path P is improved, and adopts the interconnection modification when the timing slack is improved.

### (5) Step S105

When the timing slack is not improved, the improvement determination module 124 returns the interconnection to the original state without adopting the interconnection modification. In this embodiment, when the timing slack is not improved, the improvement determination module 124 cancels the interconnection modification performed right before and returns the interconnection to the state before the interconnection modification. Alternatively, the improvement determination module 124 may cancel all of the previous interconnection modifications and return the interconnections to the state indicated by the interconnection-routed layout data 102.

### (6) Step S106

When the timing slack is improved and the interconnection modification is adopted, the cell processing module 125 resizes the cell which drives the net subjected to the interconnection modification in a range where the design constraints in terms of the timing and electromigration are satisfied. In this embodiment, the cell processing module 125 downsizes or removes the cell. The cell may be removed, when the logic value remains unchanged, as in the case where the cell is a repeater.

### (7) Step S107

The processing completion determination module 126 determines whether or not the processes for all of the listed paths are completed. The processing completion determination module 126 outputs the resultant layout data as the modified layout data 105 and completes processing when the processes are implemented for all the listed paths.

### (8) Step S108

If any of the listed paths remains unprocessed, the processing completion determination module 126 repeats the above-mentioned operation with respect to the unprocessed path.

It is preferable that the simulation module 121 performs simulation in each step (process) so as to keep a minimum distance between interconnections for avoiding a DRC violation in above-mentioned each steps (process). For example, the simulation module 121 performs interconnection rule check based on the DRC after the process of providing a space around an interconnection or the process of increasing the interconnection width of an interconnection. This provides checking whether adjacent interconnections are short-circuited in the process. It should be noted, however, that the present invention is not actually limited to this example.

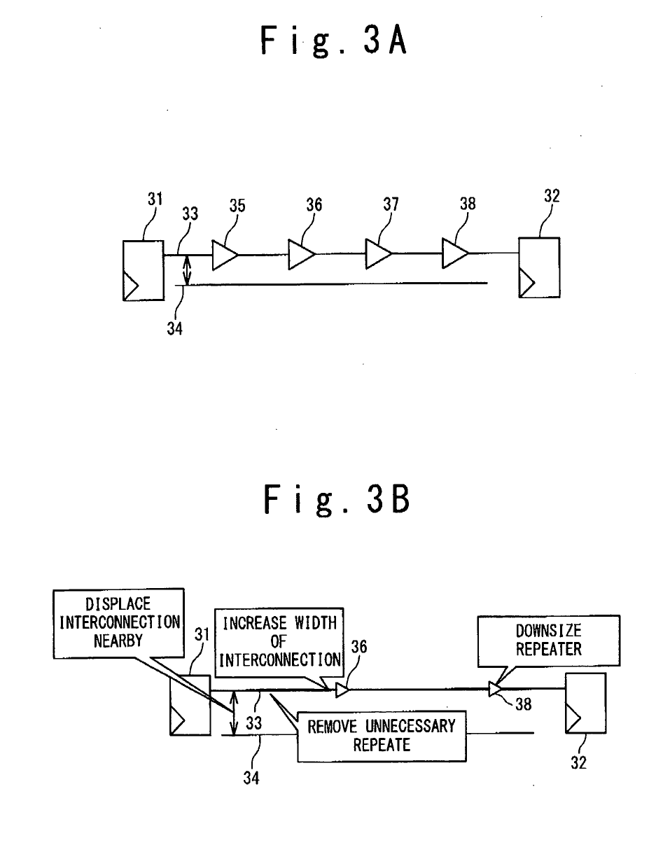

Referring to FIGS. 3A and 3B, a description is given of an example of the modification of the layout data in this embodiment.

FIG. 3A is a conceptual diagram showing exemplary contents of the interconnection-routed layout data 102. In this example, an interconnection 33 is routed between flip-flops 31 and 32. Another interconnection 34 is routed near the interconnection 33. Repeaters 35, 36, 37 and 38 are inserted in the interconnection 33. The flip-flops 31 and 32 may be each a latch circuit. The repeaters 35, 36, 37 and 38 may be each a buffer or an inverter. It should be noted, however, that the present invention is not actually limited to these examples.

FIG. 3B is a conceptual diagram showing exemplary contents of the modified layout data 105. In other words, FIG. 3B shows contents of the layout data after modification in this embodiment as comparison with the layout data shown in FIG. 3A. In FIG. 3B, as compared with FIG. 3A, the routing module 123 provides a space by displacing the interconnection 34 positioned near the interconnection 33 to increase the distance between the interconnections 33 and 34. The routing module 123 also increases the interconnection width of the interconnection 33 arranged between the flip-flops 31 and 32 by using the space thus provided. In addition, the cell processing module 125 removes the repeaters 35 and 37 which become unnecessary by the modification of the interconnection 33. Furthermore, the cell processing module 125 downsizes the repeaters 36 and 38.

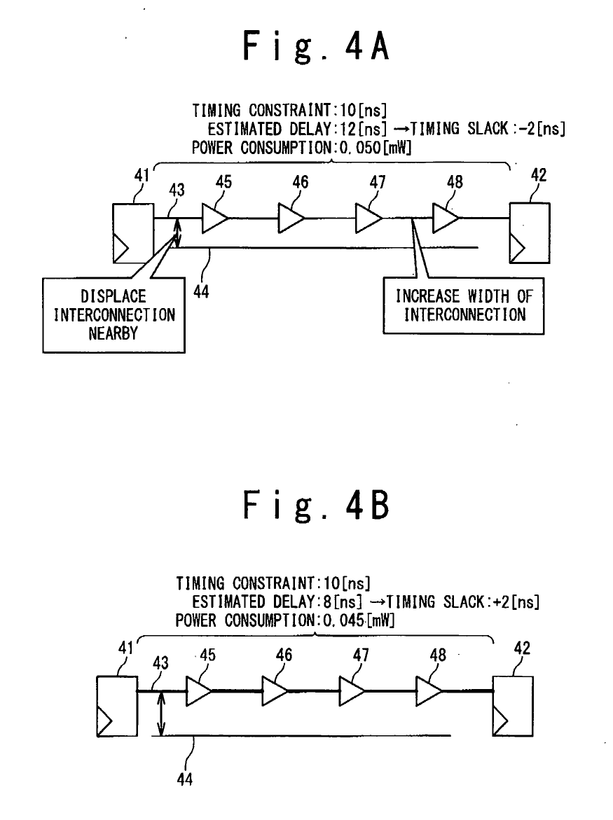

Referring to FIGS. 4A, 4B and 4C, a description is next given of a specific procedure for the modification of the layout data in this embodiment.

FIG. 4A is a conceptual diagram showing exemplary contents of the interconnection-routed layout data 102. FIG. 4A is basically similar to FIG. 3A. Here, an interconnection 43 is routed between flip-flops 41 and 42. Another interconnection 44 is routed near the interconnection 43. Repeaters 45, 46, 47 and 48 are inserted in the interconnection 43. The flip-flops 41 and 42 may be each a latch circuit. The repeaters 45, 46, 47 and 48 may be each a buffer or an inverter. It should be noted, however, that the present invention is not actually limited to these examples.

In the example of FIG. 4A, the timing constraint is “10 ns”, while the estimated delay value is “12 ns”. Accordingly, the timing slack is “−2 ns”. On the other hand, the estimated power consumption is “0.050 mW”. For the layout data shown in FIG. 4A, the routing module 123 provide a space by displacing the interconnection 44 near the interconnection 43 to allow increasing the distance between the interconnections 43 and 44. In addition, the routing module 123 increases the width of the interconnection 43 routed between the flip-flops 41 and 42. As a result the layout data shown in FIG. 4A is modified into the layout data shown in FIG. 4B.

FIG. 4B is a conceptual diagram showing exemplary contents of the layout data after the routing of the interconnection is modified. In FIG. 4B, the estimated delay value is improved to “8 ns”. As a result, the timing slack is improved to “+2 ns” since the timing constraint is “10 ns”. As a result of the increase in the width of the interconnection and resultant reduction in the interconnection resistance, power consumption is improved to “0.045 mW”. This leads to the increase in the timing slack and the generation of a timing margin, allowing resizing of the cells (the repeaters 45, 46, 47 and 48).

FIG. 4C is a conceptual diagram showing exemplary contents of the modified layout data 105 which are finally outputted.

In the example of FIG. 4C, the cell processing module 125 removes the repeater 45 which becomes unnecessary as a result of the interconnection modification. Furthermore, the cell processing module 125 downsizes the repeaters 46, 47 and 48. As a result, the estimated delay value becomes “10 ns”. Since the timing constraint is “10 ns”, the timing slack becomes “0 ns”. In addition, the power consumption is improved to “0.040 mW”, since driving power is reduced by deletion and downsizing of the cells.

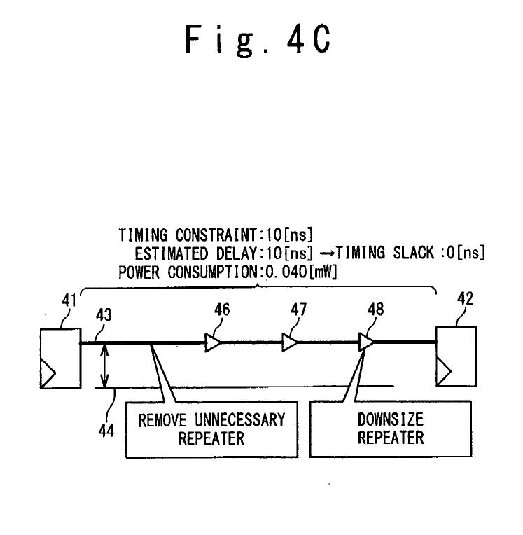

FIG. 5 shows relationship between the interconnection width (w) and the sheet resistance (Rs). In the graph shown in FIG. 5, the horizontal axis represents the interconnection width (w) and the vertical axis represents the sheet resistance (Rs). Basically, the interconnection width (w) is inversely proportional to the sheet resistance (Rs). Here, the sheet resistance (Rs) reduces as the interconnection width (w) increases for relatively narrow interconnection widths. The sheet resistance (Rs) converges to a certain value for relatively large interconnection widths, and thereafter remains substantially unchanged.

The relationship between the interconnection resistance (R) and the sheet resistance (Rs) is expressed by the following expression.

R=Rs L*L/w,

where “L” is the interconnection length and “w” is the interconnection width.

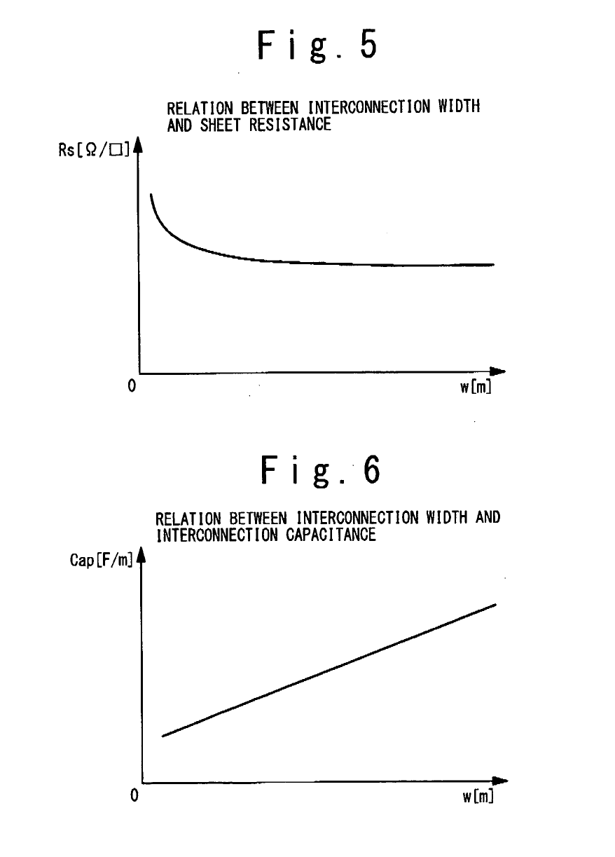

FIG. 6 shows the relationship between the interconnection width (w) and the interconnection capacitance per unit length (Cap).

S In the graph of FIG. 6, the horizontal axis represents the interconnection width (w) and the vertical axis represents the interconnection capacitance per unit length (Cap). Basically, the interconnection width (w) is proportional to the interconnection capacitance per unit length (Cap). Here, the interconnection capacitance per unit length (Cap) increases steadily as the interconnection width (w) is increased.

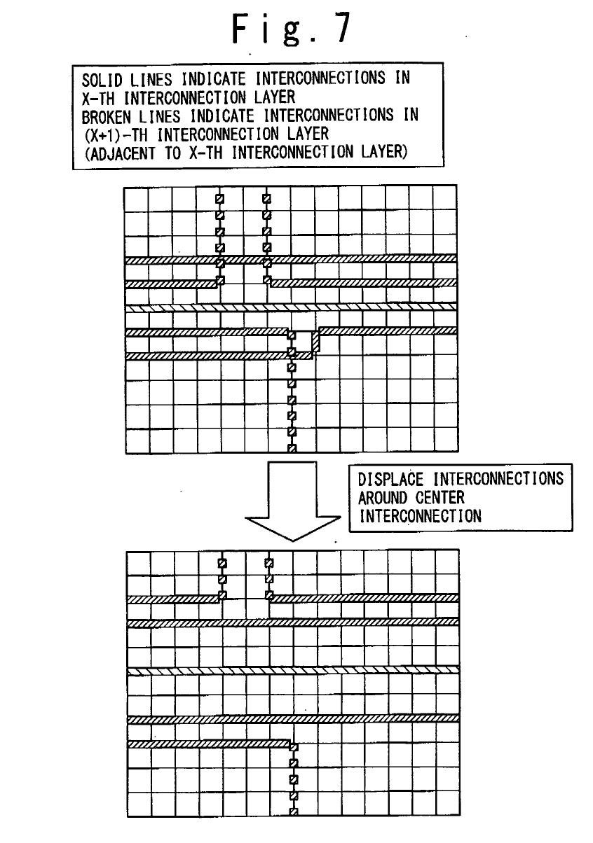

FIG. 7 shows an example of interconnection shoving. FIG. 7 shows the difference in the layout of interconnections before and after interconnections around a selected interconnection of a net within a selected path are displaced. It should be noted that the selected interconnection of the net within the selected path is shown at the center. The solid lines represent interconnections on the same layer (the X-th layer), while the broken lines represent interconnections on the layer adjacent to the X-th layer (the (X±1)-th layer). When the interconnections around the target interconnection are displaced, the arrangements of the other interconnections are adjusted in consideration with positional relationship between the displaced interconnections.

In an alternative embodiment, a shield interconnection may be inserted to form paired interconnections into the space, instead of the increase in the interconnection width. In this alternative embodiment, the effect of the interconnection resistance is alleviated by increasing the number of interconnections in place of increasing the width of the interconnection.

As described above, the interconnection modification and cell size reduction in this embodiment effectively provides improvement in the operation timing and power consumption for the interconnection-routed layout data by effectively utilizing extra interconnection resource. Specifically, in the interconnection modification and cell size reduction of this embodiment, layout data with improved timing and power consumption are generated from the interconnection-routed layout data, the design constraints related to the operation timing and electromigration, and the library describing the layouts and characteristics of standard cells and hard macros.

The design method of this embodiment of the present invention achieves reduction in the interconnection resistance of a desired interconnection by increasing the interconnection width, reducing the delay time. Thereby, the timing slack is increased, providing a timing margin. When a timing margin is provided, power consumption is reduced by lowering the current driving capacity of a cell (for example, a repeater) through reduction in the gate width.

Furthermore, the design method of this embodiment may reduce the interconnection capacitance by providing a space around the interconnection.

The design method of this embodiment effectively addresses the problem of timing that cannot be improved by introducing a repeater as in the conventional technique. Furthermore, the design method of this embodiment effectively reduces the power consumption by resizing or removing a cell by using the timing margin which is provided by the interconnection modification. The reduction in the power consumption results from the reduction in the interconnection capacitance and interconnection resistance. The effect of the improvement is substantial especially in high-density integration processes, since the timing delay due to the interconnection is dominant.

The present invention may be applied to a layout tool, a CAD (Computer Aided Design) tool and the like.

It is apparent that the present invention is not limited to the above-described embodiments, which may be modified and changed without departing from the scope of the invention.

What is claimed is:

1. A layout design system comprising:
a storage device storing interconnection-routed layout data of an integrated circuit;
a design processor which detects an interconnection violating a timing constraint based on said interconnection-routed layout data and modifies said interconnection-routed layout data so as to provide a space around said detected interconnection and to change a width of said detected interconnection by using said provided space; and
an output device outputting said modified interconnection-routed layout data.

2. The layout design system according to claim 1, wherein said design processor increases the width of said detected interconnection by using said provided space.

3. The layout design system according to claim 1, wherein said design processor inserts a shield interconnection to form paired interconnections with said detected interconnection by using said provided space.

4. The layout design system according to claim 1, wherein said detected interconnection is originally routed in a first interconnection layer in said interconnection-routed layout data, and
wherein said design processor reroutes said detected interconnection so that-said detected interconnection passes through a second interconnection layer different than said first interconnection layer.

5. The layout design system according to claim 1, wherein said design processor is responsive to a timing margin generated as a result of a change in width of said detected interconnection for removing or downsizing a cell which drives said detected interconnection.

6. The layout design system according to claim 5, wherein said design processor is adapted to reduce a gate width of said cell which drives said detected interconnection.

7. The layout design system according to claim 5, wherein said design processor includes:
a simulation module which performs simulation on said interconnection-routed layout data;
a-path detection module which detects said interconnection violating said timing constraint based on a result of said simulation;
a routing module which provides said space around said detected interconnection and modifies the width of said detected interconnection by using said space;
an improvement determination module which determines whether a timing slack of said detected interconnection is improved; and
a cell processing module which modifies said interconnection-routed layout data to resize said cell which drives said detected interconnection in a range in which design constraints are satisfied.

8. A layout design method comprising:
providing interconnection-routed layout data of an integrated circuit;
detecting an interconnection violating a timing constraint based on said interconnection-routed layout data;
modifying said interconnection-routed layout data so as to provide a space around said detected interconnection and to change a width of said detected interconnection by using said provided space; and
outputting said modified interconnection-routed layout data.

9. The layout design method according to claim 8, wherein said modifying includes increasing the width of said detected interconnection by using said provided space.

10. The layout design method according to claim 8, further comprising: inserting a shield interconnection to form paired interconnections with said detected interconnection by using said provided space.

11. The layout design method according to claim 8, wherein said detected interconnection is originally routed in a first interconnection layer in said interconnection-routed layout data, and
wherein said modifying includes: rerouting said detected interconnection so that said detected interconnection passes through a second interconnection layer different than said first interconnection layer.

12. The layout design method according to claim 8, wherein said modifying includes: removing or downsizing a cell which drives said detected interconnection in response to a timing margin generated as a result of a change in width of said detected interconnection.

13. The layout design method according to claim 12, said downsizing includes: reducing a gate width of said cell which drives said detected interconnection.

14. The layout design method according to claim 12, further comprising:
performing simulation on said interconnection-routed layout data; and
determining whether a timing slack of said detected interconnection is improved;
wherein said interconnection violating said timing constraint is detected based on a result of said simulation,
wherein said modifying includes: modifying said interconnection-routed layout data to resize said cell which drives said detected interconnection in a range in which design constraints are satisfied.

15. A computer-readable recording medium which records a program that when executed controls a computer to perform a method comprising:
providing interconnection-routed layout data of an integrated circuit;
detecting an interconnection violating a timing constraint based on said interconnection-routed layout data;
modifying said interconnection-routed layout data so as to provide a space around said detected interconnection and to change a width of said detected interconnection by using said provided space; and
outputting said modified interconnection-routed layout data.

16. The computer-readable recording medium according to claim 1S, wherein said modifying includes increasing the width of said detected interconnection by using said provided space.

17. The computer-readable recording medium according to claim 15, wherein said method further comprises: inserting a shield interconnection to form paired interconnections with said detected interconnection by using said provided space.

18. The computer-readable recording medium according to claim 15, wherein said detected interconnection is originally routed in a first interconnection layer in said interconnection-routed layout data, and
wherein said modifying includes: rerouting said detected interconnection so that said detected interconnection passes through a second interconnection layer different than said first interconnection layer.

19. The computer-readable recording medium according to claim 15, wherein said modifying includes: removing or downsizing a cell which drives said detected interconnection in response to a timing margin generated as a result of a change in width of said detected interconnection.

20. The computer-readable recording medium according to claim 19, said downsizing includes: reducing a gate width of said cell which drives said detected interconnection.

21. The computer-readable recording medium according to claim 19, wherein said method further comprises:
performing simulation on said interconnection-routed layout data; and
determining whether a timing slack of said detected interconnection is improved;
wherein said interconnection violating said timing constraint is detected based on a result of said simulation,
wherein said modifying includes: modifying said interconnection-routed layout data to resize said cell which drives said detected interconnection in a range in which design constraints are satisfied.
